(19) United States
(12) Patent Application Publication
(10) Pub. No.: US 2013/0032094 A1
(43) Pub. Date: Feb. 7, 2013

(54) ANIMAL CLIMBING ARRANGEMENT

(71) Applicants: Melody LEE, Toronto (CA); Kevin XIN, Toronto (CA)

(72) Inventors: Melody LEE, Toronto (CA); Kevin XIN, Toronto (CA)

(73) Assignee: MERRY PRODUCTS CORPORATION, Markham (CA)

(21) Appl. No.: 13/562,668

(22) Filed: Jul. 31, 2012

Related U.S. Application Data
(60) Provisional application No. 61/513,841, filed on Aug. 1, 2011.

(51) Int. Cl. A01K 15/02; A01K 29/00

(52) U.S. Cl. 119/28.5; 119/706

(57) ABSTRACT

An animal climbing arrangement includes a two-dimensional appliqué and at least one shelf for attachment to a wall. The two-dimensional appliqué is adapted for flush attachment to the wall and includes a graphical representation of at least a portion of a support structure. The at least one shelf provides a perch for a pet and is visually associated with the support structure of the two-dimensional appliqué such that the at least one shelf appears to be supported by the support structure in a two-dimensional view.

### FIELD OF THE INVENTION

The present teachings generally relate to an animal climbing arrangement. The present teachings more particularly relate to an animal climbing arrangement including a two-dimensional appliqué and at least one shelf for attachment to a wall.

### BACKGROUND

The statements in this section merely provide background information related to the present disclosure and may not constitute prior art.

Various animal climbing structures have been previously proposed. Such structures have been devised to satisfy the need of domesticated animals to climb. While known structures may have proven suitable for their intended purpose, a continuous need for improvement in the relevant art remains.

### SUMMARY

According to one particular embodiment, the present teachings provide an animal climbing arrangement associated with a wall of a room. The animal climbing arrangement includes a two-dimensional appliqué and at least one shelf for attachment to the wall. The two-dimensional appliqué is adapted for flush attachment to the wall and includes a graphical representation of at least a portion of a support structure. The at least one shelf provides a perch for a pet and is visually associated with the support structure of the two-dimensional appliqué such that the at least one shelf appears to be supported by the support structure in a two-dimensional view.

In accordance with another particular embodiment, the present teachings provide an animal climbing arrangement including a wall, a two-dimensional appliqué, and at least one three-dimensional shelf. The two-dimensional appliqué is secured to the wall and includes a graphical representation of a support structure. The at least one three-dimensional shelf is attached to the wall and provides a perch for a pet. The at least one three-dimensional shelf is visually associated with the support structure of the two-dimensional appliqué such that the at least one three-dimensional shelf appears to be supported by the support structure in a two-dimensional view.

In accordance with yet another particular application, the present teachings provide a kit for an animal climbing arrangement. The kit includes a two-dimensional appliqué and at least one shelf. The two-dimensional appliqué is adapted for flush attachment to a wall. The two-dimensional appliqué includes a graphical representation of at least a portion of a support structure. The at least one shelf is adapted for attachment to the wall. The at least one shelf provides a perch for a pet and may be visually associated with the support structure of the two-dimensional appliqué such that the at least one shelf appears to be supported by the support structure in a two-dimensional view. The kit may further include a three-dimensional scratching post.

Further areas of applicability will become apparent from the description provided herein. The description and specific examples in this summary are intended for purposes of illustration only and are not intended to limit the scope of the present disclosure.

### DRAWINGS

The present teachings will become more fully understood from the detailed description, the appended claims and the following drawings. The details within the various views of the drawings will be understood to be drawn generally to scale.

FIG. 1 is a perspective view of an animal climbing arrangement constructed in accordance with the present teachings, the animal climbing arrangement illustrated to generally include a two-dimensional appliqué and at least one shelf, the animal climbing arrangement further illustrated operatively associated with a wall.

FIG. 2 is a perspective view of another animal climbing arrangement constructed in accordance with the present teachings, the animal climbing arrangement illustrated to generally include a two-dimensional appliqué and at least one shelf, the animal climbing arrangement further illustrated operatively associated with a wall.

FIG. 3 is a perspective view of another animal climbing arrangement constructed in accordance with the present teachings, the animal climbing arrangement further illustrated to include a three-dimensional scratching post associated with a two-dimensional appliqué.

FIG. 4 is a front view of the animal climbing arrangement of FIG. 3.

FIG. 5 is a front view of another animal climbing arrangement constructed in accordance with the present teachings, the animal climbing arrangement again illustrated to include a three-dimensional scratching post associated with a two-dimensional appliqué.

### DETAILED DESCRIPTION OF VARIOUS ASPECTS

The following description is merely exemplary in nature and is not intended to limit the present disclosure, application, or uses. It should be understood that throughout the drawings, corresponding reference numerals indicate like or corresponding parts and features. The description and any specific examples, while indicating embodiments of the present disclosure, are intended for purposes of illustration only and are not intended to limit the scope of the present disclosure.

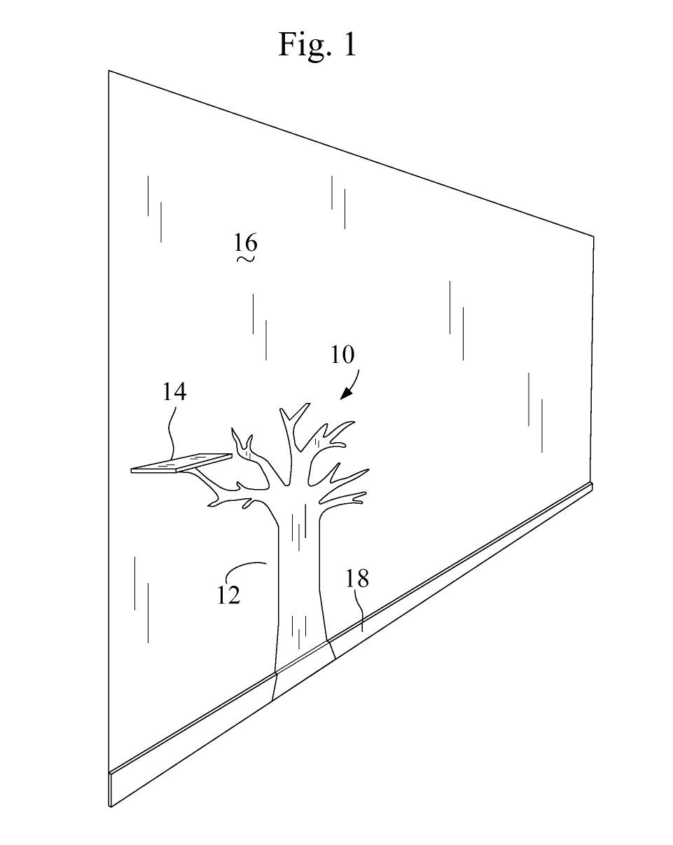

With initial reference to FIG. 1 of the drawings, an animal climbing arrangement constructed in accordance with the present teachings is illustrated and generally identified at reference character 10. The animal climbing arrangement 10 may generally include a two-dimensional appliqué 12. The animal climbing arrangement may further generally include at least one shelf 14.

The two-dimensional appliqué 12 may be particularly adapted for flush attachment to a wall 16. According to one particular application, the two-dimensional appliqué may be a releasable sticker. The two-dimensional appliqué 12 may comprise a pre-printed, thin film having one side with a releasable adhesive. The particular type of adhesive is beyond the scope of the present invention and may take any form suitable for secure and releasable attachment of the two-dimensional appliqué 12 to the wall 16. The adhesive may be reusable such that the location of the two-dimensional appliqué 12 on the wall 16 may be moved.

The flexibility of the film and adhesive cooperate to allow the two-dimensional appliqué 12 to be attached flush to the wall 16. In the application illustrated, the portion of the wall 16 to which the appliqué 12 is secured is generally planar. A lower portion of the wall 16 is shown to carry a molding 18. The thin film and adhesive of the appliqué 12 allow the appliqué to readily conform to the non-planar shape of the molding 18.

The two-dimensional appliqué 12 may be pre-printed with a graphic. The graphic may visually depict at least a portion of a support structure for the at least one shelf 14. In the embodiment illustrated, the support structure is illustrated as a tree. It will be understood by those skilled in the art that the graphical representation of the two-dimensional appliqué 12 may vary within the scope of the present invention. In other applications, the pre-printed graphic may be represent virtually any type of support structure. Such support structure may take the form of vines, for example.

In the embodiment illustrated, the at least one shelf 14 includes a single shelf. It will be understood, however, that alternative applications may incorporate a plurality of shelves. The at least one shelf 14 is a three-dimensional structure that provides a perch for a pet. The at lease one shelf 14 may be constructed of wood, plastic, metal or any other suitable material.

The at least one shelf 14 may be conventionally attached to the wall 16. For example, the at least one shelf 14 may be secured to the wall 16 with conventional shelf brackets (not shown). The particular manner of attachment will be understood to be beyond the scope of the present teachings.

The at least one shelf 14 may include a generally planar upper surface. The upper surface may define the perch for the pet. In this regard, the upper surface may have a size and shape for supporting a pet such as a house cat.

The at least one shelf 14 may be visually associated with the graphically represented support structure of the two-dimensional appliqué 12. In this regard, the shelf 14 may appear to be supported by the graphically represented support structure of the two-dimensional appliqué 12 in a two-dimensional view. In the exemplary embodiment illustrated, the shelf 14 appears to be supported by a branch of the tree. The at least one shelf 14 may be mounted over a portion of the two-dimensional appliqué 12 such that a portion of the two-dimensional appliqué is positioned between the wall and the at least one shelf.

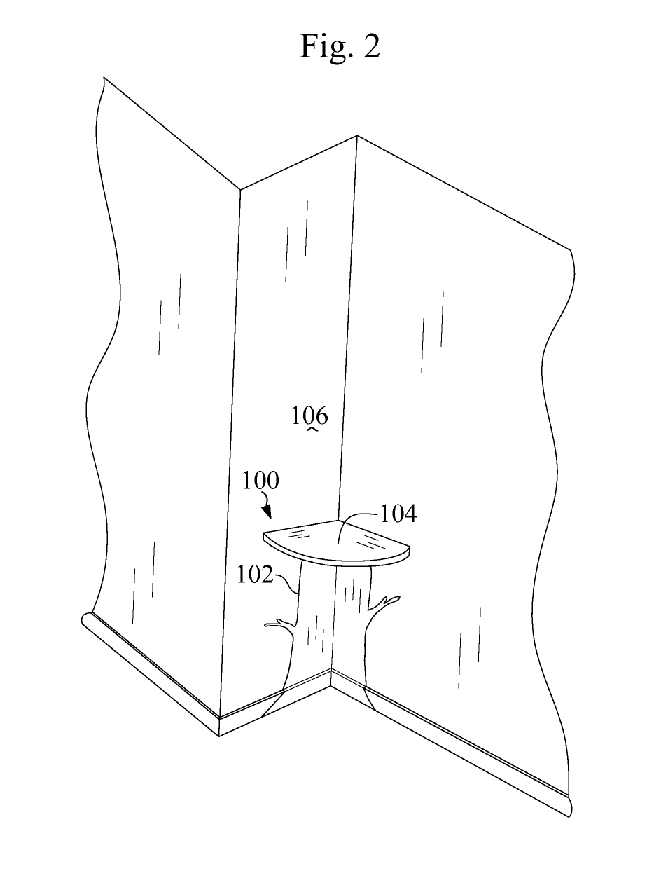

With reference to the environmental view of FIG. 2, another animal climbing arrangement constructed in accordance with the present teachings is illustrated and generally identified at reference character 100. As with the animal climbing arrangement 10, the embodiment of FIG. 2 is illustrated to generally include a two-dimensional appliqué 102 and a three-dimensional shelf 104. The animal climbing arrangement 100 of FIG. 2 differs from the previously described embodiment in that it is particularly adapted for positioning in a corner of a wall 106. To the extent not otherwise described and/or illustrated, it will be understood that the two embodiments are substantially identical.

The animal climbing device 100 is illustrated to include single shelf 104. As with the above described embodiment, the animal climbing device 100 may incorporate a plurality of shelves within the scope of the present invention. The shelf 104 is illustrated to include a pair of sides disposed at right angles to one another. As such, the shelf 14 may be placed within the corner of the wall 106 (as illustrated).

The two-dimensional appliqué 102 is illustrated to include a graphical representation of a tree trunk. The shelf 14 is mounted relative to the two-dimensional appliqué 102 so as to appear to be supported thereby in a two-dimensional view. The flexibility of the thin film of the two-dimensional appliqué 102 allows the appliqué 102 to be adhered to both of the adjacent and perpendicularly oriented wall portions of the wall 106.

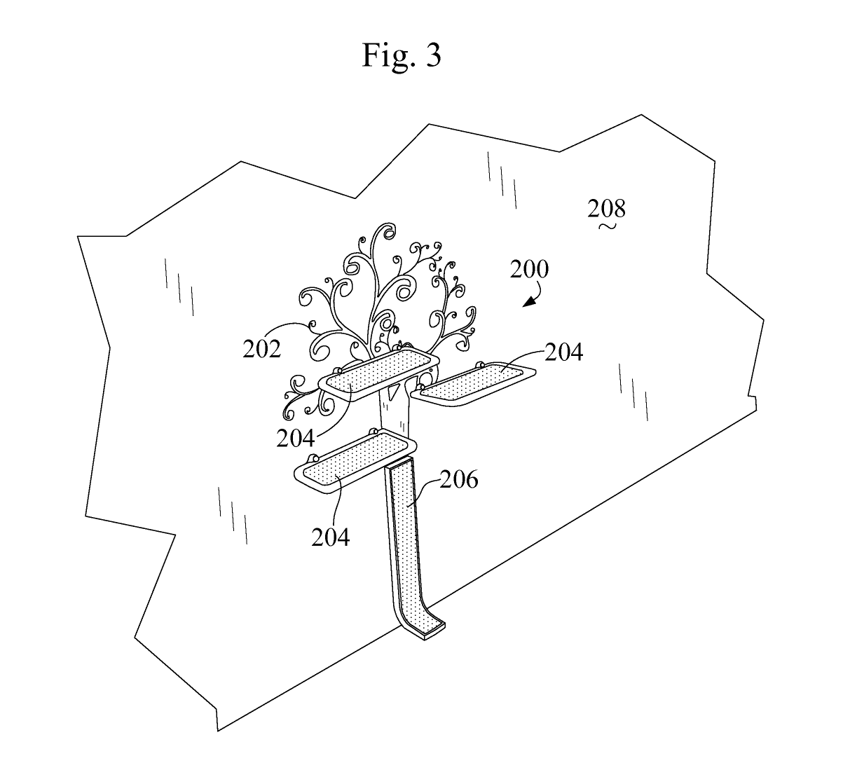

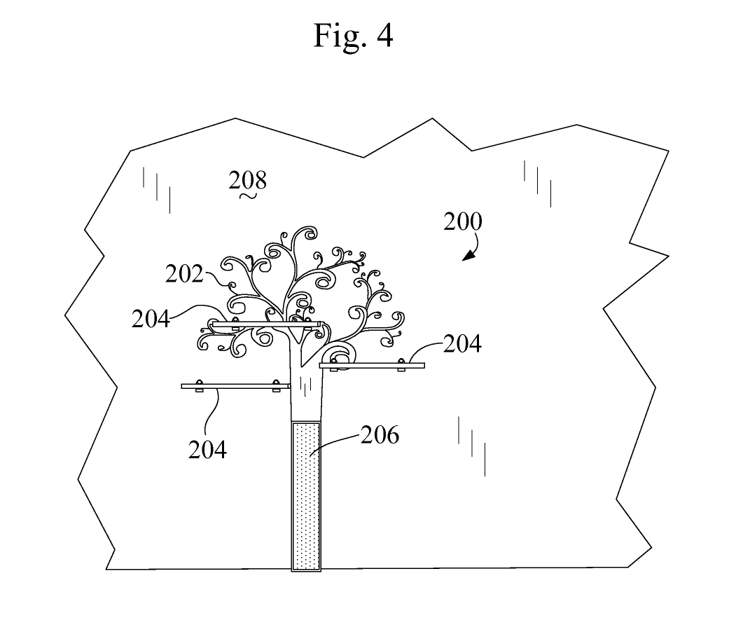

With reference to the environmental view of FIGS. 3 and 4, another animal climbing arrangement constructed in accordance with the present teachings is illustrated and generally identified at reference character 200. As with the animal climbing arrangements 10 and 100 described above, the embodiment of FIG. 3 is illustrated to generally include a two-dimensional appliqué 202 and at least one three-dimensional shelf 204.

According to one aspect, the animal climbing arrangement 200 of FIG. 3 differs from the previously described embodiment in that it additionally incorporates a three-dimensional scratching post 206. To the extent not otherwise described and/or illustrated, it will be understood that the elements of the animal climbing arrangement 200 are identical to similar elements of the embodiments described above.

In the embodiment illustrated, the arrangement is illustrated to include three shelves 204. It will be understood, however, that a greater or lesser number of shelves may be incorporated within the scope of the present invention. The shelves 204 may be adapted for mounting against a flat wall portion or within a corner of a wall.

Again, the two-dimensional appliqué 202 is illustrated to include a graphical representation of a tree trunk. The shelves 204 are mounted relative to the two-dimensional appliqué 202 so as to appear to be supported thereby in a two-dimensional view. The three-dimensional scratching post 206 is positioned relative to the two-dimensional appliqué 202 so as to appear associated therewith. In the embodiment illustrated, the scratching post 206 is supported by a floor adjacent the wall 208. In other applications, the scratching post 206 may be secured directly to the wall 208.

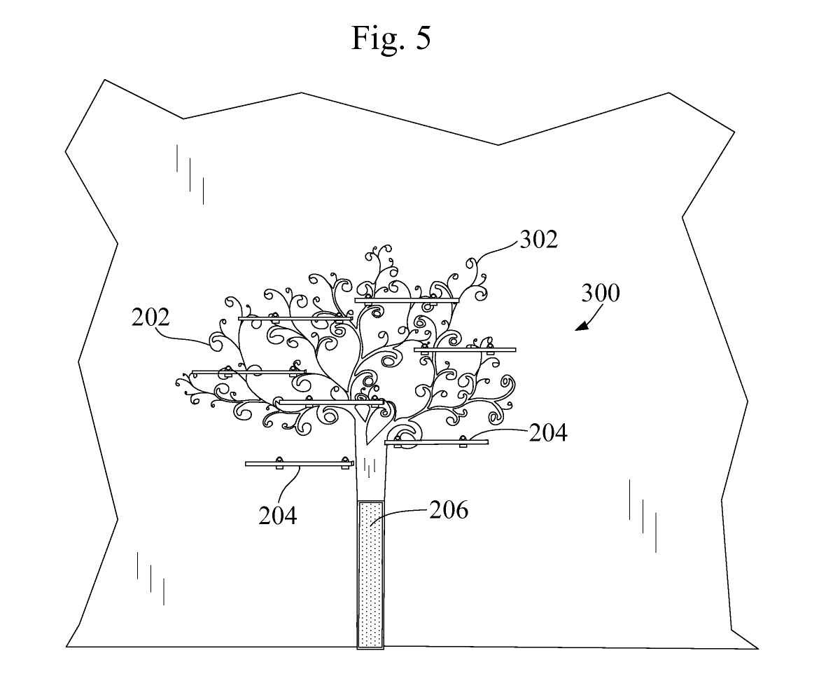

Turning finally to the environmental view of FIG. 5, another animal climbing arrangement constructed in accordance with the present teachings is illustrated and generally identified at reference character 300. As with the animal climbing arrangement of FIGS. 3 and 4, the embodiment of FIG. 5 is illustrated to generally include a two-dimensional appliqué 202, at least one three-dimensional shelf 204, and a scratching post 206. In view of the similarities, like reference characters are used to indicate like elements.

According to one aspect, the animal climbing arrangement 300 of FIG. 5 differs from the previously described embodiment of FIGS. 3 and 4 in that it incorporates additional two-dimensional appliqués 302 that are similarly adhered to the wall to extend the visual depiction of the main two-dimensional appliqué. These additional two-dimensional appliqués may be sold along with the main kit or sold as supplements to the main kits. In a similar manner, additional shelves may be included in the main kit or sold as supplements to the main kit. The climbing arrangement 300 also incorporates additional shelves 204. In the embodiment illustrated, the arrangement is illustrated to include five shelves 204. It will be understood, however, that a greater or lesser number of shelves may be incorporated within the scope of the present invention. The shelves 204 may be adapted for mounting against a flat wall portion or within a corner of a wall.

The animal climbing arrangements described above may be packaged and sold as kits that may be assembled by the consumer. While not illustrated, it will be understood that the kits may also include additional two-dimensional appliqués (not shown) that may visually cooperate with the main two-dimensional appliqué. For example, where the main two-dimensional appliqué is a tree, additional two-dimensional appliqués depicting branches may be provided. As discussed above, these additional two-dimensional appliqués may be similarly adhered to the wall to extend the visual depiction of the main two-dimensional appliqué. These additional two-dimensional appliqués may be sold along with the main kit or sold as supplements to the main kits. In a similar manner, additional shelves may be included in the main kit or sold as supplements to the main kit.

In use, the shelf 14 or 104 may be mounted at such a height that a pet (e.g., a domesticated house cat) can readily jump up on the shelf 14. Where multiple shelves are incorporated, the additional shelves may be positioned at different levels for the pet to navigate.

While specific examples have been described in the specification and illustrated in the drawings, it will be understood by those skilled in the art that various changes may be made and equivalence may be substituted for elements thereof without departing from the scope of the present teachings as defined in the claims. Furthermore, many modifications may be made to adapt a particular situation or material to the present teachings without departing from the essential scope thereof. Therefore, it may be intended that the present teachings not be limited to the particular examples illustrated by the drawings and described in the specification as the best mode of presently contemplated for carrying out the present teachings.

What is claimed is:

1. An animal climbing arrangement associated with a wall of a room, the climbing arrangement comprising:
a two-dimensional appliqué for flush attachment to the wall, the two-dimensional appliqué including a graphical representation of at least a portion of a support structure; and
at least one shelf for attachment to the wall, the at least one shelf providing a perch for a pet and being visually associated with the support structure of the two-dimensional appliqué such that the at least one shelf appears to be supported by the support structure in a two-dimensional view.

2. The animal climbing arrangement of claim 1, wherein the support structure is a tree.

3. The animal climbing arrangement of claim 1, wherein the two-dimensional appliqué is a releasable sticker.

4. The animal climbing arrangement of claim 1, wherein the two-dimensional appliqué is removable and replaceable.

5. The animal climbing arrangement of claim 1, in combination with the wall.

6. The animal climbing arrangement of claim 5, wherein the two-dimensional appliqué is mounted flush upon and directly to the wall.

7. The animal climbing arrangement of claim 1, wherein the two-dimensional appliqué includes a thin, flexible film.

8. The animal climbing arrangement of claim 1, wherein the shelf is a three-dimensional shelf.

9. The animal climbing arrangement of claim 5, wherein the wall is generally planar.

10. The animal climbing arrangement of claim 5, wherein the wall includes a pair of perpendicularly oriented portions, the two-dimensional appliqué secured to both portions.

11. The animal climbing arrangement of claim 5, wherein the at least one shelf is mounted over a portion of the two-dimensional appliqué such that a portion of the two-dimensional appliqué is positioned between the wall and the at least one shelf.

12. An animal climbing arrangement comprising:
a wall;
a two-dimensional appliqué secured to the wall, the two-dimensional appliqué including a graphical representation of a support structure; and
at least one three-dimensional shelf attached to the wall, the at least one shelf providing a perch for a pet and being visually associated with the support structure of the two-dimensional appliqué such that the at least one three-dimensional shelf appears to be supported by the support structure in a two-dimensional view.

13. The animal climbing arrangement of claim 12, wherein the two-dimensional appliqué is removable and replaceable.

14. The animal climbing arrangement of claim 12, wherein the two-dimensional appliqué is mounted flush upon and directly to the wall.

15. The animal climbing arrangement of claim 12, wherein the two-dimensional appliqué includes a thin, flexible film.

16. The animal climbing arrangement of claim 12, wherein the shelf is a three-dimensional shelf.

17. The animal climbing arrangement of claim 12, wherein the wall is generally planar.

18. The animal climbing arrangement of claim 12, wherein the wall includes a pair of perpendicularly oriented portions, the two-dimensional appliqué secured to both portions.

19. The animal climbing arrangement of claim 12, wherein the at least one three-dimensional shelf is mounted over a portion of the two-dimensional appliqué such that a portion of the two-dimensional appliqué is positioned between the wall and the at least one shelf.

20. A kit for an animal climbing arrangement comprising:
a two-dimensional appliqué for flush attachment to a wall, the two-dimensional appliqué including a graphical representation of at least a portion of a support structure; and
at least one shelf for attachment to the wall, the at least one shelf providing a perch for a pet and being visually associated with the support structure of the two-dimensional appliqué such that the at least one shelf appears to be supported by the support structure in a two-dimensional view.

21. The kit of claim 20, further comprising:
a three-dimensional scratching post.
